(19) United States
(12) Patent Application Publication
(10) Pub. No.: US 2025/0371329 A1
(43) Pub. Date: Dec. 4, 2025

(54) Mixed-Precision Model Quantization Method and System for a Residual Connection of a Trained Model

(71) Applicant: MEDIATEK INC., Hsinchu City (TW)

(72) Inventors: Min-Yuan Tseng, Hsinchu City (TW); Chia-Lin Yu, Hsinchu City (TW)

(73) Assignee: MEDIATEK INC., Hsinchu City (TW)

(21) Appl. No.: 19/204,587

(22) Filed: May 11, 2025

Related U.S. Application Data
(60) Provisional application No. 63/654,180, filed on May 31, 2024.

(51) Int. Cl. G06N 3/0495; G06N 3/0455

(52) U.S. Cl. CPC G06N 3/0495; G06N 3/0455

(57) ABSTRACT

A mixed-precision model quantization method includes loading a trained model, and quantizing the trained model with a mixed-precision setting to generate a quantized model for inference. The trained model includes a plurality of residual connections. In each residual connection, a first activation bypasses at least one operator and is added to a second activation to generate a fourth activation. The second activation is the output of the first activation after being processed by the at least one operator, The mixed-precision setting includes (a) the first activation, the second activation, and the fourth activation in at least one residual connection of the plurality of residual connections being assigned a first precision, and (b) third activations in all operators bypassed by the at least one residual connection being assigned a second precision. The third activations are generated by the bypassed operators and processed within the bypassed operators.

### CROSS REFERENCE TO RELATED APPLICATIONS

This application claims the benefit of U.S. Provisional Application No. 63/654,180, filed on May 31, 2024. The content of the application is incorporated herein by reference.

### BACKGROUND

In machine learning and deep learning, a neural network model is often used to perform tasks such as image recognition, natural language processing, and speech recognition. These models include several layers of interconnected nodes that process input data to generate predictions or classifications. During model inference, the model uses weights to compute inputs and generate activations which are intermediate states produced by each layer in the model. Model quantization is often employed to improve the efficiency of model inference. The model quantization involves using lower precision numerical representations for the model's weights and/or activations. The model quantization reduces the model's size and computational demands, leading to shorter latency.

However, reducing precision can also lead to degradation in model accuracy, as the lower precision may not be able to represent the full range of values, especially outliers. One existing solution to address the outlier problem is only to perform quantization on weights, while maintaining all activations in full precision. This approach can maintain satisfactory accuracy, but it does not fully optimize latency since the activations are not quantized. Another solution is to perform full quantization with low precision on both weights and activations to achieve good latency. However, this approach results in poor accuracy if the activations contain outliers, as low precision cannot represent the data range of outliers.

### SUMMARY

In an embodiment, a mixed-precision model quantization method is disclosed. The mixed-precision model quantization method comprises loading a trained model, and quantizing the trained model with a mixed-precision setting to generate a quantized model for inference. The trained model comprises a plurality of residual connections. In each residual connection, a first activation bypasses at least one operator and is added to a second activation to generate a fourth activation. The second activation is the output of the first activation after being processed by the at least one operator, The mixed-precision setting comprises (a) the first activation, the second activation, and the fourth activation in at least one residual connection of the plurality of residual connections being assigned a first precision, and (b) third activations in all operators bypassed by the at least one residual connection being assigned a second precision. The third activations are generated by the bypassed operators and processed within the bypassed operators. The first precision is higher than the second precision.

In another embodiment, a mixed-precision model quantization system is disclosed. The mixed-precision model quantization system comprises a processor and a memory coupled to the processor. The processor is configured to perform operations comprising loading a trained model, and quantizing the trained model with a mixed-precision setting to generate a quantized model for inference. The trained model comprises a plurality of residual connections. In each residual connection, a first activation bypasses at least one operator and is added to a second activation to generate a fourth activation. The second activation is the output of the first activation after being processed by the at least one operator. The mixed-precision setting comprises the following configurations. The first activation, the second activation, and the fourth activation in at least one residual connection of the plurality of residual connections are assigned a first precision. The third activations in all operators bypassed by the at least one residual connection are assigned a second precision. The third activations are generated by the bypassed operators and processed within the bypassed operators. The first precision is higher than the second precision.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a schematic diagram of a mixed-precision model quantization system according to an embodiment of the present invention.

FIG. 2 is a schematic diagram of a trained model stored in a memory of the mixed-precision model quantization system in FIG. 1.

FIG. 3 is a schematic diagram of a residual connection module of the trained model of the mixed-precision model quantization system in FIG. 1.

FIG. 4 is a schematic diagram of a first precision configuration of a plurality of residual connection modules of the mixed-precision model quantization system in FIG. 1.

FIG .5 is a schematic diagram of a second precision configuration of the plurality of residual connection modules of the mixed-precision model quantization system in FIG. 1.

FIG. 6 is a flow chart of a mixed-precision model quantization method performed by the mixed-precision model quantization system in FIG. 1.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternatives, modifications, and equivalents, which may be included within the spirit and scope of the claimed subject matter as defined by the appended claims. Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail to avoid unnecessarily obscure aspects and features of the subject matter.

The mixed-precision model quantization method provided by this disclosure is applied to a trained model, such as a machine learning/deep learning model. It can be understood that the trained model, after undergoing model quantization, will result in a quantized model. This can reduce the storage requirements of the model on the device (the quantized model has a smaller model size than the original trained model), increase the inference speed of the model, reduce power consumption, etc. For the sake of illustration, the trained model is exemplified using a neural network model, but the disclosure is not limited to this, for example, it can be modified to any model with a plurality of residual connections, in each residual connection, a first activation bypasses at least one operator and is added to a second activation to generate a fourth activation, wherein the second activation is the output of the first activation after being processed by the at least one operator. In the embodiment, the operators can be a series of operations. In the following embodiments, the at least one operator is illustrated by taking a series of N operators as an example, but the present disclosure is not limited to this.

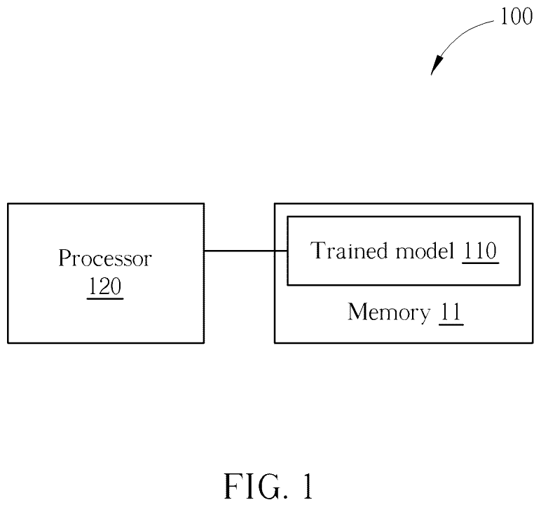

FIG. 1 is a schematic diagram of a mixed-precision model quantization system 100 according to an embodiment of the present invention. The mixed-precision model quantization system 100 can address the challenges associated with model quantization, a technique used to reduce the computational demands and size of trained models (such as neural network models) by using lower-precision numerical representations for weights and activations. Conventional quantization method can lead to shorter latency, while resulting in a degradation of model accuracy, especially when activations contain outliers. Outliers, or extreme values, can negatively impact accuracy because the lower precision may not be able to represent their full data range. The mixed-precision model quantization system 100 mitigates the problem of the conventional quantization method by employing a strategy that uses different precision levels within the same model. In the process of model quantization, the key idea is to maintain higher precision for specific activations that are more likely to contain outliers, while using lower precision for other activations to improve latency. The mixed-precision model quantization system 100 is effective in the trained model with residual connections, where activations are summed, and potentially accumulating outliers. By assigning the activations in residual connections in full or high precision, the mixed-precision model quantization system 100 prevents the loss of outlier information, maintaining accuracy. At the same time, most computation-heavy operations are still quantized, ensuring that the model benefits from the latency improvements of quantization. In the following embodiments, the mixed-precision model quantization system 100 is designed to reduce latency and improve accuracy of neural network models having residual connections.

In FIG. 1, the mixed-precision model quantization system 100 includes a processor 120 and a memory 11. The processor 120 is coupled to the memory 11. The memory 11 is used for storing a program code, for example, the program code may comprise a trained model 110 that the system is designed to process. Understandably, the trained model 110 (e.g., a neural network model like an LLM) has completed its training phase, and thus possesses fixed weights. By storing the trained model 110 in the memory 11, the processor 120 can load the trained model 110 from the memory 11 and access all activations of the trained model 110 for the subsequent quantization stages. Specifically, the processor 120 retrieves the trained model 110 from the memory 11 to apply the mixed-precision model quantization method, ultimately generating a quantized model optimized for inference and latency.

The processor 120 functions as a quantization tool or quantization function applied to the trained model 110 stored in the memory 11. This processor 120 executes a mixed-precision model quantization process on the trained model 110, selectively quantizing different activations within the model's structure. Specifically, it can quantize an input activation of each residual connection module, an output activation of each residual connection module, and the intermediate activations generated and processed through multiple operators within each residual connection module. A purpose of quantization activations by the processor 120 is to generate a quantized model that effectively balances inference accuracy and latency by assigning appropriate precision levels to these various activations.

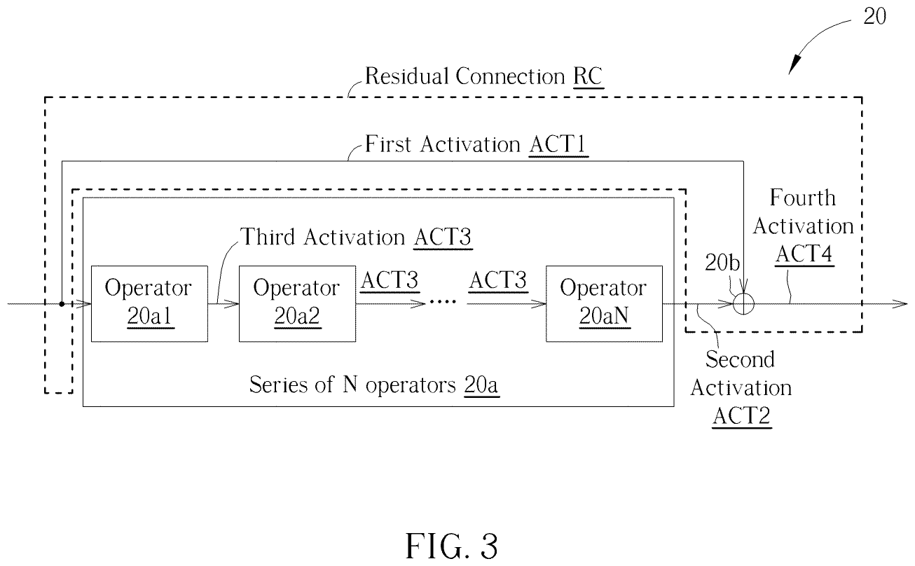

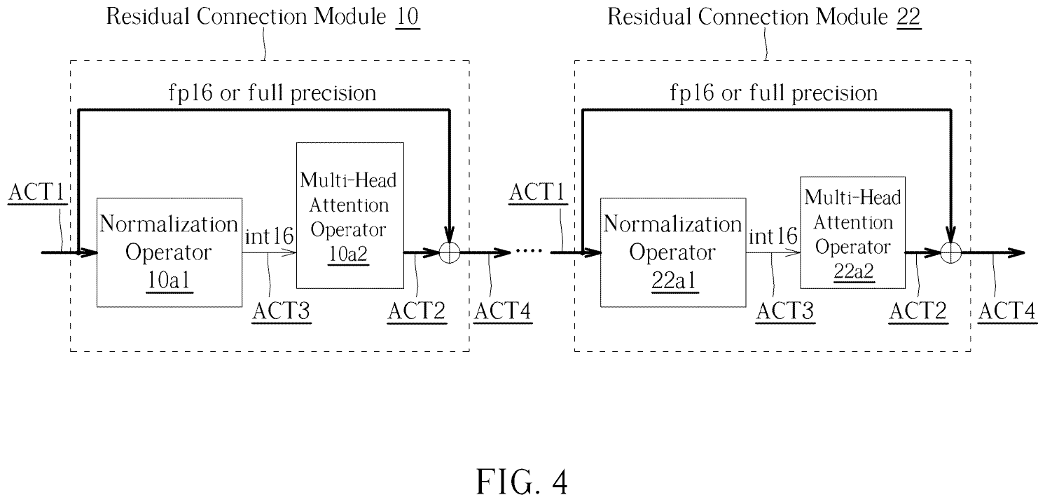

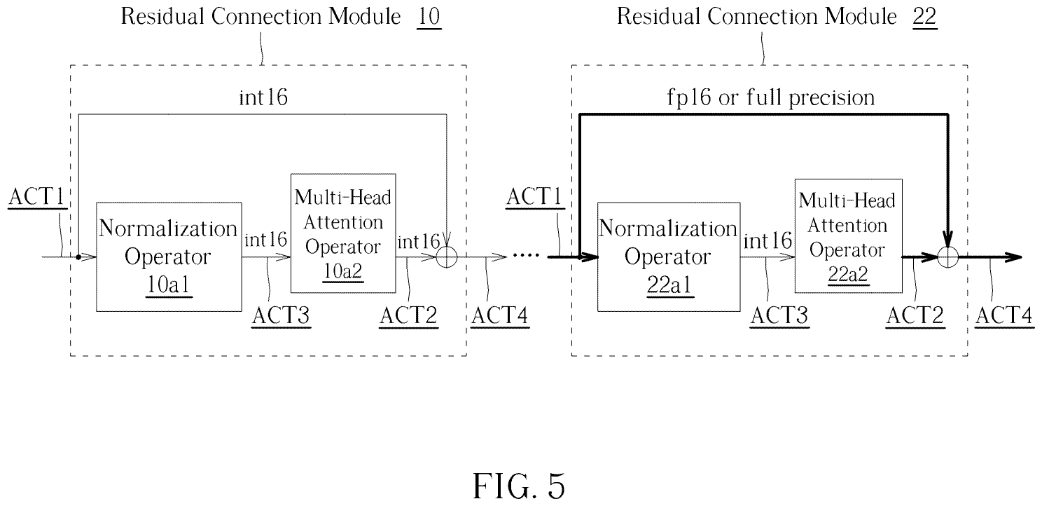

In brief, for the mixed-precision model quantization process on the trained model 110, the processor 120 loads a trained model 110 from the memory 11. The trained model 110 comprises a plurality of residual connections. In each residual connection, a first activation (ACT1 as shown in FIG. 3) bypasses at least one operator and is added to a second activation (ACT2 as shown in FIG. 3) to generate a fourth activation (ACT4 as shown in FIG. 4). The second activation is the output of the first activation after being processed by the at least one operator. The processor 120 quantizes the trained model 110 with a mixed-precision setting to generate a quantized model for inference. The mixed-precision setting comprises the following configurations. The first activation, the second activation, and the fourth activation in at least one residual connection of the plurality of residual connections are assigned a first precision. The third activations in all operators bypassed by the at least one residual connection are assigned a second precision. The third activations are generated by the bypassed operators and processed within the bypassed operators. The first precision is higher than the second precision.

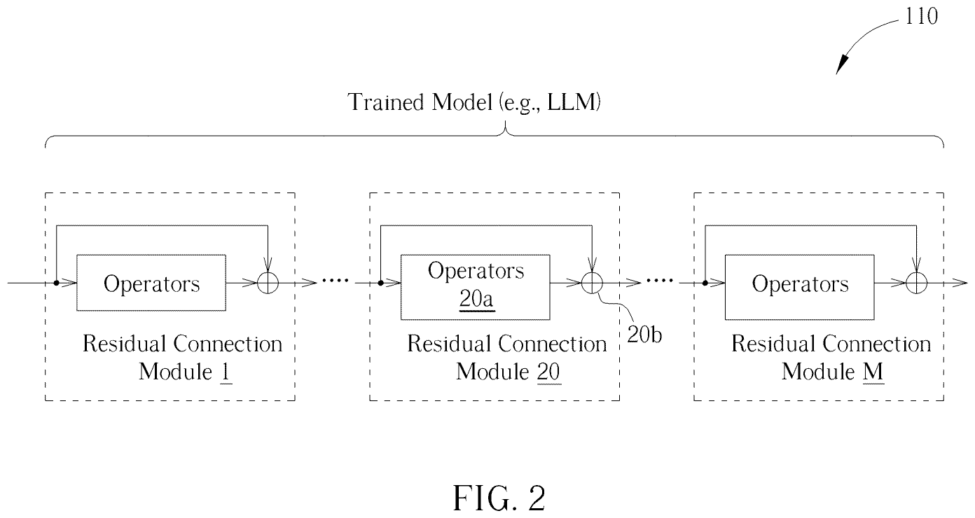

FIG. 2 is a schematic diagram of the trained model 110 stored in the memory 11 of the mixed-precision model quantization system 100. The trained model 110 may include a plurality of residual connection modules 1 to M, for example, operators in different residual connection modules may be different. The plurality of residual connection modules 1 to M are coupled in series. M represents a positive integer indicating the total number of residual connection modules within the trained model 110. For simplicity, a residual connection module 20 is described in the embodiment. The residual connection module 20 may be a design used in machine learning and deep learning architectures. The residual connection module 20 includes a series of N operators 20a and an adder 20b. The series of N operators 20a can include, but are not limited to, various types of layers or functions commonly found in neural networks of the trained model 110, such as fully-connected layers, multi-head attention layers, normalization layers, convolution layers, or other mathematical operations. In the residual connection module 20, the input of the series of N operators 20a is combined with the output of the series of N operators 20a by the adder 20b to generate a new activation. The design of the residual connection module 20 is intended to address issues like outlier accumulation and to improve accuracy in quantized model inference. In one embodiment, the neural network model is the LLM (large language model). The residual connection modules 1 to M can be transformer layers of the LLM, that is, a plurality of residual connections are within transformer layers of the LLM. The mixed-precision model quantization system 100 can be applied to quantize the trained model 110. For example, the processor 120 of the mixed-precision model quantization system 100 can assign different precision levels to activations for “at least one” residual connection module. This strategic assignment of precision in the embodiments can balance the trade-off between model accuracy and computational efficiency (latency) during model inference. Details of the mixed-precision model quantization method are illustrated below.

FIG. 3 is a schematic diagram of the residual connection module 20 of the trained model 110 of the mixed-precision model quantization system 100. As previously mentioned, the residual connection module 20 may include the series of N operators 20a and the adder 20b. In detail, the series of N operators 20a include operators 20a1 to 20aN coupled in series. N is a positive integer greater than zero. In FIG. 3, the series of N operators 20a includes an input terminal used for receiving a first activation ACT1, and an output terminal used for outputting a second activation ACT2. It should be understood that the “activation” refers to the intermediate data produced by each layer or operator within the trained model 110. For example, during model inference, inputs are computed using fixed weights, and these computations result in the activation. Thus, the activation can be regarded as the output of each layer's or operator's computation, serving as the input to subsequent processes. In the embodiment, as shown by FIG. 1 and FIG. 2, the “first activation ACT1” may be defined as outputs generated from the previous residual connection module (or equivalently defined as inputs of the residual connection module 20). The second activation ACT2 is defined as outputs generated from the series of N operators 20a. The adder 20b is coupled to the input terminal of the series of N operators 20a and the output terminal of the series of N operators 20a, and used for outputting fourth activation ACT4. Further, in FIG. 2, the residual connection module 20 may comprise a residual connection RC and at least one operator (such as the series of N operators 20a shown by FIG. 2) skipped/bypassed by the residual connection RC. In the residual connection RC, the first activation ACT1, which may be outputted from a previous layer/operator (such as the previous residual connection module), may bypass the at least one operator (20a1 to 20aN) and is added to the second activation ACT2, wherein the second activation ACT2 is the output of the first activation after being processed by the at least one operator (20a1 to 20aN) bypassed by the corresponding residual connection. For example, in FIG. 3, in the residual connection RC, the first activation ACT1 is added to the second activation ACT2 to generate the fourth activation ACT4. The first activation ACT1 may refer to the output of the previous operator. The at least one operator may refer to the parts that do not involve the residual connection RC in the residual connection module. For example, in the at least one operator (such as, the series of N operators 20a), the third activations ACT3 are generated by the series of N operators 20a and processed within the series of N operators (operators 20a1 to 20aN). In the embodiment, as shown by FIG. 3, the at least one operator follows the sequential flow of operators 20a1 to 20aN. However, the present invention is not limited to this.

In the embodiment, after the trained model 110 is quantized, the processor 120 can generate the quantized model in the memory 11. The quantized model is configured to generate inference outputs. To reduce latency and improve accuracy during the inference of quantized model, during the model quantization, the activations (ACT1, ACT2, and ACT4) in at least one residual connection RC are configured to meet a first precision, and the activations (ACT3) in the at least one residual connection module associated with the at least one residual connection that is not in the residual connection RC are configured to meet a second precision. For example, in the embodiment, a first precision is assigned to the first activation ACT1, the second activation ACT2 and the fourth activation ACT4 in the at least one residual connection RC. A second precision is assigned to the third activation ACT3 in all operators bypassed by the at least one residual connection RC, wherein the third activations ACT3 are generated by the bypassed operators (e.g., such as the operators 20a1-20aN) and processed within the bypassed operators. The first precision is higher than the second precision. Here, the “precision” refers to the level of detail used to represent a value. In machine learning (ML) computing, precision dictates the number of bits used to store a number. More bits allow for finer granularity and a wider range of representable values. That is to say, the precision refers to the degree of exactness with which a value is expressed. Common numerical representations include floating-point numbers (such as fp32, fp16) and integers (such as int32, int16, int8, int4). For example, it can be understood that fp32 has higher precision than fp16, fp16 has higher precision than int16, and int16 has higher precision than int4, and so on. The first precision is determined based on the precision configurations of the trained model 110. The second precision is determined based on latency configurations of the trained model 110. In one embodiment, the weights in the trained model 110 are fixed. The trained model 110 is then run with mixed precision settings, using lower precision for activations not in the residual connection RC (third activations ACT3), and higher precision for activations in the residual connection RC (first activation ACT1, second activation ACT2, and the fourth activation ACT4). In one embodiment, a full precision format for the trained model may be a 32-bit floating-point data format. Specifically, the first activation ACT1, the second activation ACT2, and the fourth activation ACT4 in the at least one residual connection RC may have the full precision format or a precision lower than the full precision format, such as a16-bit floating-point data format (fp16). The third activations ACT3 not in the at least one residual connection may have a 16-bit integer data format (int16).

It can be understood that, in the mixed-precision model quantization system 100, the “mixed-precision model quantization” mechanism can be applied to “all” residual connection modules, or can be applied to “at least one” residual connection module. For clarification, FIG. 4 illustrates of performing mixed-precision model quantization in “all” residual connection modules. FIG. 5 illustrates of performing mixed-precision model quantization in “one” residual connection module. Details are illustrated below. For presentation convenience, in FIG. 4 to FIG. 5, the “bold arrowed lines” refer to the paths of the residual connections to which the mixed precision model quantization is applied. The first type of activations (i.e., the first activation ACT1, the second activation ACT2, and the fourth activation ACT4) in the residual connection are assigned to the higher precision. The second type of activations (i.e., the activations ACT3) not in the residual connections are assigned to the lower precision. Reasons for balancing the trade-off between model accuracy and computational efficiency (latency) of the mixed-precision model quantization system 100 based on such mixed-precision configurations are also illustrated below.

In the mixed-precision model quantization system 100, “outliers” refer to certain values in the activations that can cause accuracy issues. As previously mentioned, the activation is the intermediate state produced by each layer or operator in the model. The activation may include some outliers. Specifically, outliers have a large data range that low-precision data types cannot represent accurately. For example, the “int16” can only represent integers between −32768 and +32767. The “fp16” can represent values between −65504 and 66504. If the activations have an outlier value of, say, 50000, quantizing it to “int16” would result in a loss of information and negatively affect accuracy. In other words, outliers are values that are far outside the typical range of data, and these outliers can cause problems when trying to represent the data in a lower precision format after model quantization. To address this issue, the mixed-precision model quantization system 100 assigns different precision levels to different activations. Activations in the residual connection (ACT1, ACT2, and ACT4) are assigned to a higher precision format. Assigning higher precision to the activations in the residual connection allows these activations to accurately represent and propagate outliers, preserving the model's accuracy. For example, if there are outliers in the first activation ACT1 and/or the second activation ACT2, the fourth activation ACT4 maintains the information integrity of the outliers. Further, in the residual connection module, activations not in the residual connection (ACT3) are assigned to the lower precision format. Since the skipped/bypassed operators do not accumulate outliers in the same way, using lower precision for these activations can reduce computational load and latency.

Further, in the mixed-precision model quantization system 100, at least one weight of the series of N operators 20a may be quantized in the trained model 110. At least one weight of the series of N operators 20a is fixed. The primary reason for quantizing the weights of the series of N operators 20a is to enable smaller model inference and achieve shorter latency. Original weights represented in higher precision formats like floating-point 32 (fp32), contribute to increased model complexity and higher computational demands during inference. By quantizing the weights, their numerical representations are reduced (e.g., from fp32 to int4 or int8), which leads to a decrease in model size and computational load. As a result, since at least one quantized weight may have the 4-bit integer (int4) or 8-bit integer (int8) data format, the model requires less time to perform calculation, providing latency reduction. In one embodiment, the processor 120 quantizes all weights in all operators bypassed by the at least one residual connection, for example, the quantized weights may have the 4-bit integer (int4) data format. After the precisions of all activations and weights of the trained model 110 are configured, the mixed-precision model quantization system 100 can use the “quantized model” for generating inference outputs during an inference stage, providing high accuracy in conjunction with low latency.

FIG. 4 is a schematic diagram of the first precision configuration of the plurality of residual connection modules 10 to 22 of the mixed-precision model quantization system 100. FIG. 4 presents the plurality of residual connection modules 10 to 22 coupled in series, demonstrating the application of the mixed-precision model quantization method. Within each residual connection module, signal flows and processing of activations are depicted. The first activation ACT1 is regarded as inputs of each residual connection module. The first activations ACT1 is processed by a series of operators of each residual connection module. In FIG. 4, the series of operators may include a normalization operator and a multi-head attention operator. Each residual connection module may be used in the transformer layer. The normalization operator receives the first activation ACT1 and performs a normalization function. The normalization operator can be any kind of normalization operator. The normalization operator includes but is not limited to a root mean square (RMS) normalization operator, a layer normalization operator, and a group normalization factor. The output of the normalization operator is then passed to the multi-head attention operator.

For example, for the residual connection module 10, the series of operators of the residual connection module 10 includes a normalization operator 10a1 and a multi-head attention operator 10a2 coupled to the normalization operator 10a1. The multi-head attention operator 10a2 further processes the third activation ACT3. Notably, the weights within the multi-head attention operator 10a2 are quantized to an integer 4-bit integer data format (“int4”). However, the present invention is not limited to this. For example, all weights in the trained model 110 (e.g., including weights of the normalization operator 10a1 and weights of the multi-head attention operator 10a2) may be quantized to a low precision (such as, an integer 4-bit integer data format).

For the residual connection module 10, the third activations ACT3 are generated and processed within the series of operators, specifically generated by the normalization operator 10a1 and processed within the multi-head attention operators 10a2. The third activation ACT3 may be specified to have a 16-bit integer data format (“int16”). The second activation ACT2 is outputted from the multi-head attention operators 10a2. In the residual connection module 10, the second activation ACT2 may be specified to have a 16-bit floating-point data format (fp16) or a full precision data format (such as a 32-bit floating-point data format (fp32)). An adder is present in each residual connection module. The adder is used for combining the first activation ACT1 with the second activation ACT2 to generate the fourth activation ACT4 having the same precision as the first activation ACT1 with the second activations ACT2. In FIG. 4, the fourth activation ACT4 in the residual connection module 10 may have the 16-bit floating-point data format (fp16) or the full precision data format.

In one embodiment, all residual connection modules 10 to 22 can be configured to different precise levels to provide optimal balance between model accuracy and computational efficiency (latency) during model inference. Since the mixed-precision mechanism and connection structure of the residual connection module 22 are similar to the residual connection module 10. Thus, details are omitted here. Taking the two residual connection modules 10 and 22 herein as an example, if the mixed-precision model quantization is applied only to residual connection module 10, then the third activation ACT3 processed using low precision corresponds to the activation ACT3 within the operators in the residual connection module 10. Similarly, the weights processed using low precision correspond to all the weights within the operators in the residual connection module 10. The third activations irrelevant to the residual connection module 10 may be not configured to low precision. In other words, the mixed-precision method of the embodiments can be performed on a per-residual connection module basis.

In one embodiment, “at least one” residual connection module can be configured to different precise levels. It should be understood that, since the occurrence points of outliers can be predicted in advance, to optimize latency while maintaining accuracy, the mixed-precision model quantization system 100 can merely allocate higher precision to the residual connection modules where outliers occur, so that information on the outliers will not be distorted. Further, the mixed-precision model quantization system 100 can allocate lower precision to the residual connection modules where outliers do not occur, so that latency can be further optimized. Details are illustrated below.

FIG. 5 is a schematic diagram of a second precision configuration of the plurality of residual connection modules 10 to 22 of the mixed-precision model quantization system 100. FIG. 5 presents the plurality of residual connection modules 10 to 22 coupled in series, demonstrating the application of the mixed-precision model quantization method. However, signal flows, activation definitions, and structure of the mixed-precision model quantization system in FIG. 5 are similar to those in FIG. 4. Thus, details are omitted here. As previously mentioned, since the occurrence points of outliers can be predicted in advance, the mixed-precision model quantization system 100 can allocate lower precision to the residual connection modules where outliers do not occur, so that latency can be further optimized. For example, in the residual connection module 10, activations in the residual connection of the residual connection module 10 (ACT1, ACT2, ACT4) can be specified to have the 16-bit integer data format (“int16”, lower precision), the same as activations in the non-residual connection (ACT3). Therefore, the latency can be further optimized in the residual connection module 10 where outliers do not occur. For example, in the residual connection module 22, activations in the residual connection of the residual connection module 22 (ACT1, ACT2, ACT4) may be specified to have the 16-bit floating-point data format (“fp16”, higher precision). By doing so, information on the outliers will not be distorted through the residual connection module 22. Therefore, the accuracy can be maintained in the residual connection module 22.

In some embodiments, to achieve latency improvements in the trained model 110, the mixed-precision model quantization system 100 can quantize the weights of the operators. The rationale behind this is that original weights, often represented in higher precision formats such as fp32, contribute to increased model complexity and higher computational demands during inference. By quantizing the weights, their numerical representations are reduced, for example, from fp32 to int4 or int8, which leads to a decrease in model size and computational load, consequently reducing the time required to perform calculations and thus providing latency reduction. However, in other embodiments, the mixed-precision model quantization system 100 will still quantize an operator even if that operator doesn't have weights, as long as quantizing that operator contributes to the overall latency optimization. Any technology modification falls into the scope of the embodiments.

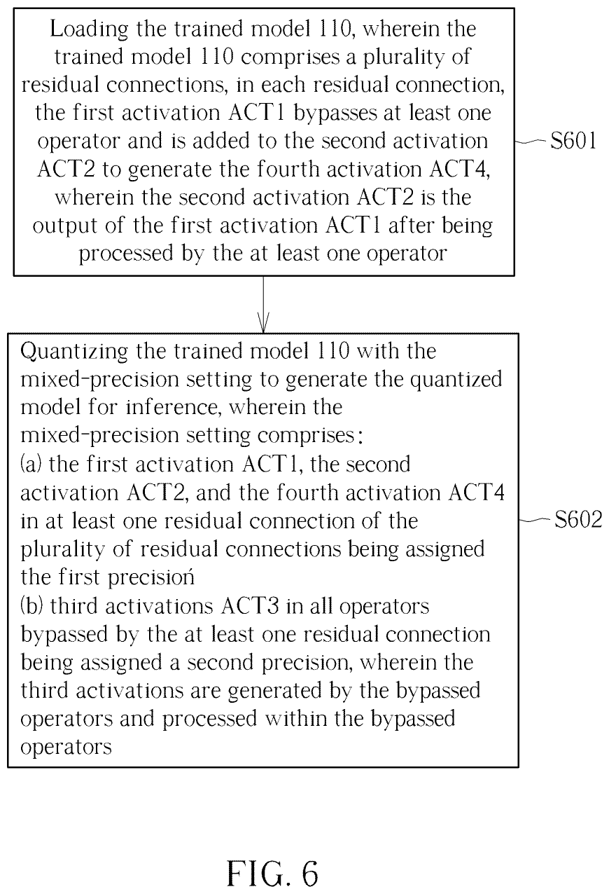

FIG. 6 is a flow chart of a mixed-precision model quantization method performed by the mixed-precision model quantization system 100. The mixed-precision model quantization method includes steps S601 to S602. Steps S601 to S602 are illustrated below.
step S601: loading the trained model 110, wherein the trained model 110 comprises a plurality of residual connections, in each residual connection, the first activation ACT1 bypasses at least one operator and is added to the second activation ACT2 to generate the fourth activation ACT4, wherein the second activation ACT2 is the output of the first activation ACT1 after being processed by the at least one operator;
step S602: quantizing the trained model 110 with the mixed-precision setting to generate the quantized model for inference, wherein the mixed-precision setting comprises:
   (a) the first activation ACT1, the second activation ACT2, and the fourth activation ACT4 in at least one residual connection of the plurality of residual connections being assigned the first precision;
   (b) third activations ACT3 in all operators bypassed by the at least one residual connection being assigned a second precision, wherein the third activations are generated by the bypassed operators and processed within the bypassed operators.

Details of steps S601 to S602 are previously illustrated. Thus, they are omitted here. The mixed-precision model quantization system 100 offers a solution to the trade-off between accuracy and latency in model quantization. As known, model quantization uses lower precision in numerical representation to allow smaller model inference and shorter latency. However, lower precision can cause model accuracy degradation due to the limited numerical range. The mixed-precision model quantization system 100 addresses this issue by using mixed precision setting, employing different precision levels in the same model to balance latency and accuracy. The key idea is to maintain higher precision specifically for activations in residual connections. Keeping residual connections at higher precision is important because activations in residual connections tend to accumulate outliers, which negatively affects accuracy after quantization, as low precision cannot represent the data range of outliers. By keeping full or high precision in residual connections, the mixed-precision model quantization system 100 can maintain the information integrity of the outliers since the outliers' values can be represented using full or high precision. Moreover, the mixed-precision model quantization system 100 retains the benefits of model inference latency from quantization because most computation-heavy operations are still quantized. As a result, the mixed-precision model quantization system 100 improves accuracy while introducing only acceptable latency.

In summary, the embodiments illustrate a mixed-precision model quantization system and a mixed-precision model quantization method. By setting activations in residual connections to high or full precision, a significant improvement in accuracy can be achieved with only a minimal increase in latency. The embodiments leverage the characteristic of value accumulation in activations within residual connections. When outliers occur in activations, they tend to propagate and accumulate through subsequent layers due to the design of residual connections. By employing high or full precision for these activations, the embodiments ensure that outliers do not compromise accuracy during quantized model inference. In contrast to conventional methods that suffer from accuracy degradation due to the limited numerical range of low-precision representation, the embodiments effectively mitigate the negative impact of outliers on accuracy, while maintaining the latency benefits of model quantization. Therefore, the mixed-precision model quantization system can be applied to various models incorporating residual connections, such as LLMs with transformer architectures.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mixed-precision model quantization method comprising:
loading a trained model comprising a plurality of residual connections, wherein in each of the plurality of residual connections, a first activation bypasses at least one operator and is added to a second activation to generate a fourth activation, wherein the second activation is the output of the first activation after being processed by the at least one operator; and
quantizing the trained model with a mixed-precision setting to generate a quantized model for inference;
wherein the mixed-precision setting comprises:
the first activation, the second activation, and the fourth activation in at least one residual connection of the plurality of residual connections are assigned a first precision; and
third activations in all operators bypassed by the at least one residual connection are assigned a second precision, wherein the third activations are generated by the bypassed operators and processed within the bypassed operators; and
wherein the first precision is higher than the second precision.

2. The method of claim 1, wherein the trained model is a neural network model.

3. The method of claim 1, wherein the first precision is determined based on precision configurations of the trained model, and the second precision is determined based on latency configurations of the trained model.

4. The method of claim 1, wherein a full precision format for the trained model is 32-bit floating-point data format, and the first precision is represented by the full precision format or is a precision lower than the full precision format.

5. The method of claim 1, wherein a full precision format for the trained model is 32-bit floating-point data format, the first precision is represented by the full precision format or a 16-bit floating-point data format, and the second precision is represented by a 16-bit integer data format.

6. The method of claim 1, further comprising:
quantizing all weights in all operators bypassed by the at least one residual connection.

7. The method of claim 6, wherein the quantized weights have a 4-bit integer data format.

8. The method of claim 1, further comprising:
generating inference outputs by the quantized model after the trained model is quantized.

9. The method of claim 1, wherein the trained model is a Large Language Model (LLM), and the plurality of residual connections are within transformer layers of the LLM.

10. The method of claim 1, wherein the at least one operator comprises a normalization operator and a multi-head attention operator.

11. A mixed-precision model quantization system comprising:
a processor; and
a memory coupled to the processor,
wherein the processor is configured to perform operations comprising:
loading a trained model stored in the memory, wherein the trained model comprises a plurality of residual connections, in each of the plurality of residual connections, a first activation bypasses at least one operator and is added to a second activation to generate a fourth activation, and the second activation is the output of the first activation after being processed by the at least one operator, and
quantizing the trained model with a mixed-precision setting to generate a quantized model for inference;
wherein the mixed-precision setting comprises:
the first activation, the second activation, and the fourth activation in at least one residual connection of the plurality of residual connections are assigned a first precision; and
third activations in all operators bypassed by the at least one residual connection are assigned a second precision, the third activations are generated by the bypassed operators and processed within the bypassed operators; and
wherein the first precision is higher than the second precision.

12. The system of claim 11, wherein the trained model is a neural network model.

13. The system of claim 11, wherein the first precision is determined based on precision configurations of the trained model, and the second precision is determined based on latency configurations of the trained model.

14. The system of claim 11, wherein a full precision format for the trained model is 32-bit floating-point data format, and the first precision is represented by the full precision format or is a precision lower than the full precision format.

15. The system of claim 11, wherein a full precision format for the trained model is 32-bit floating-point data format, the first precision is represented by the full precision format or a 16-bit floating-point data format, and the second precision is represented by a 16-bit integer data format.

16. The system of claim 11, wherein the operations performed by the processor further comprises: quantizing all weights in all operators bypassed by the at least one residual connection.

17. The system of claim 16, wherein the quantized weights have a 4-bit integer data format.

18. The system of claim 11, wherein the operations performed by the processor further comprises: generating inference outputs by the quantized model after the trained model is quantized.

19. The system of claim 11, wherein the trained model is a Large Language Model (LLM), and the plurality of residual connections are within transformer layers of the LLM.

20. The system of claim 11, wherein the at least one operator comprises a normalization operator and a multi-head attention operator.
